(19) United States
(12) Patent Application Publication
(10) Pub. No.: US 2006/0027424 A1
(43) Pub. Date: Feb. 9, 2006

(54) Elevator control method and apparatus for implementing the method

(75) Inventor: Pekka Jahkonen, Hyvinkaa (FI)

Correspondence Address: BIRCH STEWART KOLASCH & BIRCH, PO BOX 747, FALLS CHURCH, VA, 22040-0747, US

(73) Assignee: KONE CORPORATION, Helsinki (FI)

(21) Appl. No.: 11/202,018

(22) Filed: Aug. 12, 2005

Related U.S. Application Data
(63) Continuation of application No. PCT/FI04/00088, filed on Feb. 24, 2004.

(30) Foreign Application Priority Data
Feb. 27, 2003 (FI) FI20030303

(51) Int. Cl. B66B 1/28

(52) U.S. Cl. 187/293

(57) ABSTRACT

A elevator control method wherein the elevator motor is controlled in such manner that the velocity of the elevator follows a speed reference. When the elevator is decelerating, the motor is controlled by a speed adjustment method during the initial deceleration phase, and during the final deceleration phase the motor is controlled by a position adjustment method. The instant of transition from speed adjustment to position adjustment is determined substantially by means of the elevator speed curve.

The present invention relates to an elevator control method as defined in the preamble of claim 1 and to an apparatus for controlling an elevator as defined in the preamble of claim 5.

In advanced alternating-current elevator drives, the motor is generally controlled by means of a frequency converter, which is used to adjust the torque and rotational speed of the motor. An individual elevator travel may be regarded as consisting of a departure, acceleration, a constant-speed portion, deceleration and stopping at a landing. The motor is normally controlled by using a speed reference such that the elevator will follow a predetermined speed curve as accurately as possible. An important task in elevator operation is to stop the elevator car exactly at the landing without sudden speed changes or without a need to move the car in the reverse direction.

Usually when an elevator is to be stopped, constant deceleration is used, and just before the stop the deceleration is changed at a preselected rate of change or jerk to achieve a final rounding of the speed curve. This method works well if the elevator follows the speed reference accurately.

In prior art, there are solutions designed to make the elevator follow the speed curve as accurately as possible down to the final deceleration. Such a solution is described e.g. in international patent application PCT/FI97/00265. However, the solution disclosed in this publication is complicated and it can therefore not be applied in all elevator drives.

However, when torque control is used in an elevator, following the speed reference is difficult because the torque control determines the overall torque of the system. Increasing the gain increases the torque, but this leads to problems of stability.

The object of the invention is to develop a new method for controlling an alternating-current motor for use in an elevator, a method that is simple to implement and enables an elevator car to be reliably stopped exactly at a floor level. To achieve this, the method of the invention is characterized by the features disclosed in the characterization part of claim 1. Similarly, the apparatus of the invention is characterized by the features disclosed in the characterization part of claim 5. Certain other embodiments of the invention are characterized by the features disclosed in the sub-claims.

By the solution of the invention, at the final stage before the car stops at the landing, the motor is controlled by using a position reference. This results in a simple and reliable adjustment that is directly dependent on the distance to the desired stopping position. During the rest of the travel curve, a speed reference is observed, thus utilizing the advantages of speed adjustment.

According to a preferred embodiment, when the elevator is decelerating, the motor is controlled by a speed adjustment method at the final stage of deceleration, and at the final stage of deceleration the motor is controlled by a position adjustment method, and the instant of transition from speed adjustment to position adjustment is determined substantially by means of the elevator speed curve. The method of the invention has no effect on the normal travel time of the elevator, nor does it make the control during actual travel more complicated.

According to a second preferred embodiment, the instantaneous value of the speed curve is observed continuously and the motor control method is determined utilizing the instantaneous value of the speed curve.

According to yet another embodiment of the method, the remaining distance to the stopping position is continuously monitored and the motor control method is determined utilizing this remaining distance.

According to a further embodiment, when the elevator is decelerating, the motor is controlled by a speed adjustment method until a point is reached where the ratio between the acceleration and the speed is the same as the ratio between the remaining distance and the speed, and at this point the control is changed over to position adjustment. In this way, a control method is achieved that is independent of other drive parameters.

An apparatus for controlling an elevator according to yet another embodiment of the invention, said apparatus comprising means allowing the elevator motor to be controlled on the basis of position data and means whereby a selection can be made as to whether the elevator is to be controlled by means of a speed reference or by means of a position reference.

In the following, the invention will be described in detail with reference to an embodiment and the attached drawings, wherein

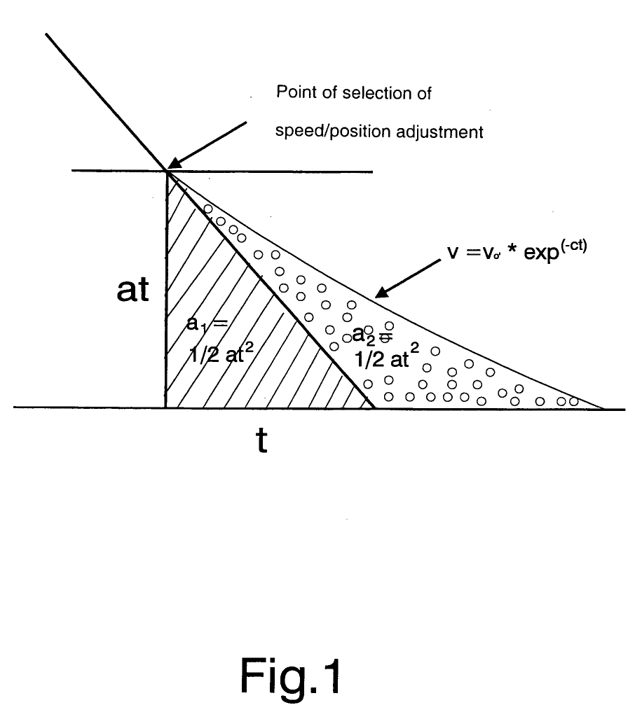

FIG. 1 illustrates the final deceleration of the speed curve, and

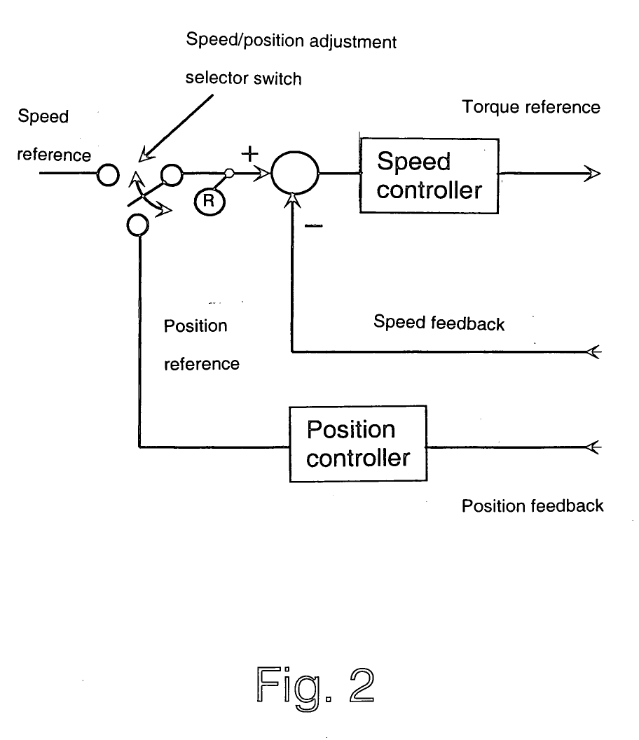

FIG. 2 is a diagrammatic representation of a control system implementing the method of the invention.

According to FIG. 1, in normal operation the elevator travel curve comprises an initial acceleration, a constant acceleration stage, a constant velocity portion, a constant deceleration stage and a final deceleration. At the deceleration stage, the elevator's velocity is reduced with a constant deceleration, which is represented by portion vₐ of the speed curve in FIG. 1. At the constant deceleration stage, as is well known, equation v₁=a*t₁, where a is deceleration and t is time, applies for velocity, and equation s₁=½*a*t₁² applies for distance. In other words, when the elevator comes with constant deceleration to a halt, it travels through a distance of s₁=½*a*t₁² in time t₁. If a final rounding is added to the speed curve at the end of the deceleration stage, in which case the change in deceleration, i.e. the jerk is constant, and a jerk value is chosen such that the stopping distance is doubled, i.e. s₂=2*s₁=a*t₁², then the velocity can be resolved. For example, if the velocity falls exponentially and final rounding is started at instant t=1/c=s₁/v₁=v₁/a, then the values of velocity, deceleration and distance from the landing become simultaneously zero with a great accuracy. In this situation, the following equations apply:
v=v₁*e^{-c*t},
d=1/c*v,
a=−c*v.

Thus, FIG. 1 illustrates the definition of the instant of time when the transition from speed adjustment to position adjustment occurs. The suggested instant is the instant when the remaining distance (a₁+a₂) equals twice the distance a₁ that the elevator would have to travel if no final rounding were made.

FIG. 2 represents a motor control system that implements the function of the invention. The ratio between the velocity and acceleration of the elevator is compared to the ratio between the remaining distance and the velocity. When these two ratios are equal, control is changed over from the constant deceleration stage to the final deceleration and the velocity is controlled in accordance with the exponential function v=v₁*e^{-c*t}. According to FIG. 2, the transition to position adjustment is accomplished by connecting the actual value signal R of the speed controller to the position reference instead of to the speed reference, the position reference being a certain function of the distance to the landing measured by a position feedback arrangement.

The above description is not to be regarded as a limitation of the sphere of patent protection; instead, the embodiments of the invention may be freely varied within the limits defined in the claims.

1. Elevator control method, wherein the elevator motor is controlled in such a manner that the velocity of the elevator follows a speed reference, and that, when the elevator is decelerating, the motor is controlled by a speed adjustment method during the initial deceleration phase and that the motor is controlled by a position adjustment method during the final deceleration phase, characterized in that the instant of transition from speed adjustment to position adjustment is determined substantially by means of the elevator speed curve.

2. Method according to claim 1, characterized in that the instantaneous value of the speed curve is monitored continuously and the motor control method is determined utilizing the instantaneous value of the speed curve.

3. Method according to claim 1 and 2, characterized in that the remaining distance to the stopping position is continuously monitored and the motor control method is determined utilizing this remaining distance.

4. Method according to claim 1, characterized in that, when the elevator is decelerating, the motor is controlled by the speed adjustment method until a point is reached where the ratio between the acceleration and the spped is the same as the ration between the remaining distance and the speed, and that at this point the control is changed over to a position adjustment.

5. Apparatus for controlling an elevator, said apparatus comprising means allowing the elevator to be controlled on the basis of a position reference or a speed reference, characterized in that the apparatus comprises means for determine the instant of the transition whereby the elevator motor control is selected from the speed reference to the position point.
